(19) United States
(12) Patent Application Publication
(10) Pub. No.: US 2017/0354285 A1
(43) Pub. Date: Dec. 14, 2017

(54) CONNECTOR FOR BLIND-TYPE CURTAIN AND BLIND-TYPE CURTAIN COMPRISING SAME

(71) Applicant: Sung Chul KIM, Gyeyang-gu Incheon (KR)

(72) Inventor: Sung Chul KIM, Gyeyang-gu Incheon (KR)

(21) Appl. No.: 15/538,423

(22) PCT Filed: Dec. 31, 2015
(86) PCT No.: PCT/KR2015/014551

§ 371 Date: Jun. 21, 2017

(30) Foreign Application Priority Data
Jan. 15, 2015 (KR) 10-2015-0007577
Dec. 30, 2015 (KR) 10-2015-0190145

(51) Int. Cl. A47H 13/02; E06B 9/36; A47H 23/05; A47H 15/00

(52) U.S. Cl. CPC A47H 13/02; A47H 23/05; E06B 9/364; A47H 2015/005

(57) ABSTRACT

The present invention relates to a blind-type curtain and particularly, to a blind-type curtain capable of allowing curtain blinds to be individually separated and washed or replaced and allowing a light-transmitting state and a blackout state to be easily controlled since a plurality of curtain blinds are connected to each other by a connector, and allowing the curtain blinds to easily form a “U” shape since an extension plate is formed. The present invention can increase aesthetics by fastening adjacent blackout curtain parts through the connector. In addition, the present invention enables light transmittance in the curtain state, and can use a blackout curtain effect by using rotation (the angle control of verticals) when adjacent blackout curtain parts are fastened through a connector. Additionally, the present invention facilitates individual washing and repair due to contamination or damage since a plurality of curtain blinds can be individually separated. Furthermore, the present invention can promote an aesthetic appeal since the curtain blind comprises a weight at the lower end thereof, thereby allowing the curtain blind to be tightly pulled. Moreover, the present invention can promote an aesthetic appeal by allowing the color and the pattern of curtain blinds to be different since a plurality of curtain blinds can be individually separated. The present invention can provide a blind-type curtain having a perfect “U” shape since the extension plate for supporting a light-transmitting curtain part is formed at the connector.

### CROSS-REFERENCE TO RELATED APPLICATIONS

This application claims priority from Korean Patent Application No. 10-2015-0007577, filed on Jan. 15, 2015 and Korean Patent Application No. 10-2015-0190145 filed on Dec. 30, 2015, in the Korean Intellectual Property Office, the disclosure of which is incorporated herein by reference in its entirety.

### TECHNICAL FIELD

The present disclosure relates to a connector for a blind-type curtain and a blind-type curtain comprising the same, and more particularly, to a connector for a blind-type curtain, which connects a plurality of curtain blinds to one another such that the curtain blinds can be individually separated for washing or replacement purpose and it is easy to control between light transmitting state and blackout state, and which has an extension plate configured to allow the curtain blinds to form a U-shape easily, and a blind-type curtain having the connector.

### BACKGROUND ART

Curtains are draperies used for covering windows or doors. Such curtains may be generally categorized into a light transmitting curtain through which external light is passed, and a blackout type curtain by which external light is blocked. Since the curtains are categorized in the manner described above, it is inconvenient because a user has to select either of the light transmitting curtain or the blackout type curtain, and if the blackout type curtain is necessary while using the light transmitting curtain, the user has to remove the light transmitting curtain and arrange the blackout type curtain instead.

Blinds may be used instead of curtains to address the shortcomings mentioned above, in which case the user is able to control light transmitting state and the blackout state by adjusting an angle of rotation of the verticals. However, since the blind is made of a material different from the net material that is usually used for curtains, the user will not have the same effect as he or she is using curtains. There also is a problem that when the conventional curtains or blinds are contaminated or deformed, the user has to separate the entire curtains or blinds from the rail to wash, repair, or replace the same.

Accordingly, in order to address inconvenience of the user, curtain is necessary, in which it is possible to adjust the light transmitting state and the blackout state with only one curtain, and it is easy to wash, repair, or replace in the event contamination or deformation occurs.

### DISCLOSURE

### Technical Problem

Exemplary embodiments of the present inventive concept overcome the above disadvantages and other disadvantages not described above. Also, the present inventive concept is not required to overcome the disadvantages described above, and an exemplary embodiment of the present inventive concept may not overcome any of the problems described above.

Exemplary embodiments of the present inventive concept overcome the above disadvantages and other disadvantages not described above. Also, the present inventive concept is not required to overcome the disadvantages described above, and an exemplary embodiment of the present inventive concept may not overcome any of the problems described above.

According to an embodiment, a technical objective is to provide a connector for a blind-type curtain with which it is easy to switch between light transmitting state and blackout state and it is also easy to wash, repair or replace when contamination or deformation occurs, and a blind-type curtain having the connector.

### Technical Solution

In order to achieve the objects mentioned above, in an exemplary embodiment, a connector for a blind-type curtain is provided such that, in a plurality of curtain blinds including a light transmitting curtain part and blackout curtain parts provided on both sides of the light transmitting curtain part, the connector is provided on the blackout curtain parts to fasten adjacent blackout curtain parts to each other, and includes: a first clip plate having a first base plate, and a first fastening member protruding from one region of one surface of the first base plate; and a second clip plate having a second base plate having a corresponding shape to the first base plate, a second fastening member formed on one region of one surface of the second base plate to be coupled with the first fastening member, and a connection ring extending upwardly from a center of an edge of the second base plate.

In order to achieve the objects mentioned above, in an exemplary embodiment, a blind-type curtain including a plurality of curtain blinds is provided, in which the curtain blinds may include a light transmitting curtain part and blackout curtain parts which are provided on both sides of the light transmitting curtain part and which are fastened with the blackout curtain parts adjacent thereto by a connector, and in which the connector may include: a first clip plate having a first base plate, and a first fastening member protruding from one region of one surface of the first base plate; and a second clip plate having a second base plate having a corresponding shape to the first base plate, a second fastening member formed on one region of one surface of the second base plate to be coupled with the first fastening member, and a connection ring extending upwardly from a center of an edge of the second base plate.

In an exemplary embodiment, a first clip plate having a spike protruding from the other region of one surface of the first base plate; and a spike coupling hole formed in the other region of one surface of the second base plate to be coupled with the spike, may be additionally included.

In an exemplary embodiment, a first extension plate extending from one edge of the first base plate; and a second extension plate extending from one edge of the second base plate and having a corresponding shape to the first extension plate may be included. When the curtain blinds are in a curtain state by the first extension plate and the second extension plate, the light transmitting curtain part may be kept in a U-shape.

The first extension plate and the second extension plate may be elastic members.

The curtain blinds may be woven, and the light transmitting curtain part may have a less thickness than the blackout curtain parts.

Further, the connector may be provided on an upper portion of the blackout curtain parts, and a connection ring to be connected with a curtain rail may be formed on an upper portion of the connector. The connector may include a first connector having a slit formed therein, and a second connector having a projection formed thereon to be fastened with the slit.

An angle of rotation of the curtain blinds may be controlled with the connector. A plurality of curtain blinds may have different colors and patterns from each other, and may additionally include a weight detachably attached to a lower end of the curtain blinds.

### Advantageous Effects

The present disclosure provides a connector for a blind-type curtain and a blind-type curtain having the same, in which adjacent blackout curtain parts are fastened with each other by the connector such that the blind-type curtain has a rounded shape with enhanced aesthetic appeal.

In addition, the present disclosure provides a connector for a blind-type curtain and a blind-type curtain having the same, in which an extension plate is formed, extending on an edge of the connector such that the blind-type curtain can be easily formed into a U-shape.

In addition, the present disclosure provides a connector for a blind-type curtain and a blind-type curtain having the same, in which light is transmitted in the curtain state, while blackout curtain effect can be provided upon rotation (i.e., upon adjustment of angle of the vertical) while the adjacent blackout curtain parts are fastened with each other by the connector.

In addition, the present disclosure provides a connector for a blind-type curtain and a blind-type curtain having the same, in which a plurality of curtain blinds can be individually separated and can be individually washed and repaired when contamination or damage occurs.

In addition, the present disclosure provides a connector for a blind-type curtain and a blind-type curtain having the same, in which further enhanced aesthetic appeal can be provided, since a weight is provided at a lower end of the curtain blinds to tightly pull the curtain blinds.

In addition, the present disclosure provides a connector for a blind-type curtain and a blind-type curtain having the same, in which further enhanced aesthetic appeal can be provided, since a plurality of curtain blinds can be individually separated and thus can have different colors and patterns from one another.

Accordingly, the present disclosure provides a connector for a blind-type curtain and a blind-type curtain having the same, in which a perfect U-shaped blind-type curtain can be provided by forming, on the connector, an extension plate for supporting the light transmitting curtain part.

### DESCRIPTION OF DRAWINGS

The above and/or other aspects of the present inventive concept will be more apparent by describing certain exemplary embodiments of the present inventive concept with reference to the accompanying drawings, in which:

FIG. 1 is a perspective view of a curtain blind according to a first exemplary embodiment of the present disclosure;

FIGS. 2 and 3 are perspective views of a connector for a blind-type curtain according to a first exemplary embodiment of the present disclosure;

FIG. 4 is a perspective view of a first clip plate of a blind-type curtain according to a first exemplary embodiment of the present disclosure;

FIG. 5 is a perspective view of a second clip plate of a blind-type curtain according to a first exemplary embodiment of the present disclosure;

FIGS. 6 and 7 are perspective views of a first connector for a blind-type curtain according to a modified example of a first exemplary embodiment of the present disclosure;

FIG. 8 is a perspective view of a second connector for a blind-type curtain according to a modified example of a first exemplary embodiment of the present disclosure;

FIG. 9 is a perspective view illustrating a state of a curtain of a blind-type curtain according to a first exemplary embodiment of the present disclosure;

FIG. 10 is a top view of FIG. 9;

FIG. 11 is a perspective view illustrating a blind-type curtain in a blackout state according to a first exemplary embodiment of the present disclosure;

FIG. 12 is a top view of FIG. 11;

FIG. 13 is a perspective view of a curtain blind according to a second exemplary embodiment of the present disclosure;

FIG. 14 is an exploded perspective view of a blind-type curtain connector according to a second exemplary embodiment of the present disclosure;

FIG. 15 is a perspective view illustrating a blind-type curtain connector being connected to a rail ring, according to a second exemplary embodiment of the present disclosure;

FIG. 16 is a perspective view illustrating a blind-type curtain connector coupled according to a second exemplary embodiment of the present disclosure;

FIGS. 17 to 27 are perspective views illustrating a blind-type curtain connector coupled according to a modified example of a second exemplary embodiment of the present disclosure;

FIG. 28 is a perspective view illustrating a blind-type curtain in a curtain state according to a second exemplary embodiment of the present disclosure;

FIG. 29 is a top view of FIG. 28; and

FIG. 30 is a top view illustrating a blind-type curtain in a blackout state according to a second exemplary embodiment of the present disclosure.

### MODE FOR DISCLOSURE

Certain exemplary embodiments of the present inventive concept will now be described in greater detail with reference to the accompanying drawings.

However, the present disclosure is not limited to the exemplary embodiments described below, but may be implemented in a variety of forms different from each other. The exemplary embodiments are provided to complete the disclosure and to assist in a comprehensive understanding of the present inventive concept. In the following description, same drawing reference numerals are used for the same components even in different drawings.

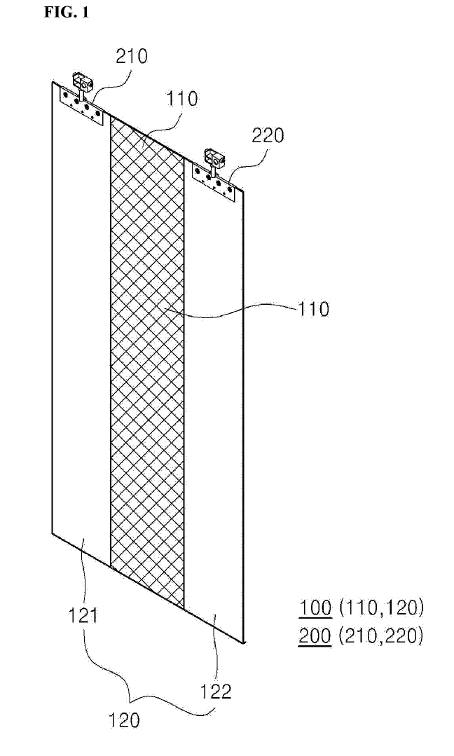

FIG. 1 is a perspective view of a curtain blind according to a first exemplary embodiment of the present disclosure.

As illustrated in FIG. 1, a blind-type curtain according to a first exemplary embodiment includes a plurality of curtain blinds 100, and connectors 200 for connecting a plurality of separate curtain blinds 100 to one another.

The curtain blind 100 is one unit set that constructs a blind-type curtain. In an exemplary embodiment, a plurality of such curtain blinds 100 may be used to construct a blind-type curtain. According to an exemplary embodiment, the curtain blind 100 includes a light transmitting curtain part 110, and blackout curtain parts 120 provided on both sides of the light transmitting curtain part 110, respectively.

The light transmitting curtain part 110 may be woven into a form of a net that allows external light to penetrate thereinto. The light transmitting curtain part 110 may be fabricated into a rectangular shape, and may be added with a variety of colors and patterns. Further, the light transmitting curtain parts 110 of a plurality of curtain blinds 100 may or may not have identical color or pattern, or these may have identical pattern and different colors, or identical color and different patterns.

The blackout curtain parts 120 may be provided on both sides of the light transmitting curtain part 110. Accordingly, the light transmitting curtain part 110 together with the blackout curtain parts 120 construct one curtain blind 100. The blackout curtain parts 120 include a first blackout curtain part 121 and a second blackout curtain part 122 provided on both sides of the light transmitting curtain part 110, respectively. The blackout curtain parts 120 may have a greater thickness than the light transmitting curtain part 110 and thus provide a more blackout effect than the light transmitting curtain part 110. However, according to an exemplary embodiment, the blackout curtain parts 120 do not completely shield the light as a general blackout curtain does. That is, the blackout curtain parts 120 may have a greater thickness than the light transmitting curtain part 110 so as to block the light slightly more than the light transmitting curtain part 110. Of course, the exemplary embodiments are not limited to the example provided above. Accordingly, the blackout curtain parts 120 may be formed so as to completely block the light. Further, the blackout curtain parts 120 may preferably be fabricated into the same rectangular shape as the light transmitting curtain part 110. The blackout curtain parts 120 may be separately fabricated and connected to the light transmitting curtain part 110, although it would be more effective that the blackout curtain parts 120 are woven together with the light transmitting curtain part 110.

The connectors 200 are provided to fasten adjacent blackout curtain parts 120 to each other. In an exemplary embodiment, fastening of the connectors 200 causes the light transmitting curtain part 110 to bend, whereby the curtain blind 100 has a U-shape. To this purpose, the connectors 200 include a first connector 210 provided at the first blackout curtain part 121, and a second connector 220 provided at the second blackout curtain part 122. Further, connecting rings are formed on upper sides of the connectors 200 to be engaged with the rail installed on ceiling, and so on. It is possible to control an angle of rotation of the curtain blind 100 by rotating via the connecting rings. Since the present disclosure relates to a curtain, it is of course possible that, like other general curtains, the blind-type curtain according to the exemplary embodiment may be open or closed in a lateral direction by moving the curtain blind 100 on the rail.

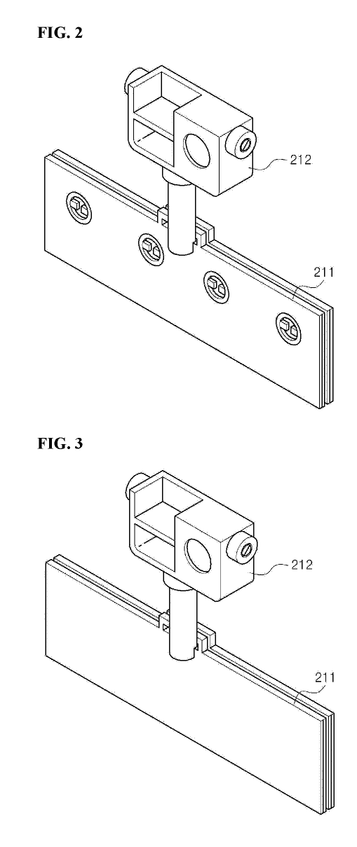

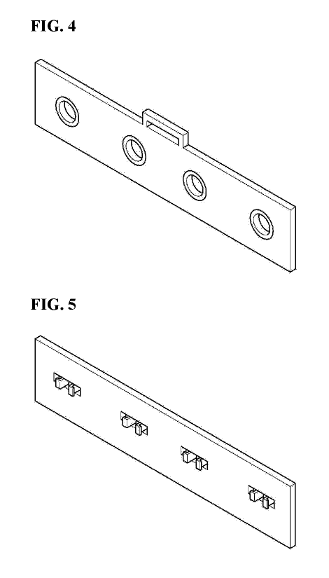

FIGS. 2 and 3 are perspective views of a connector for a blind-type curtain according to a first exemplary embodiment of the present disclosure. Further, FIG. 4 is a perspective view of a first clip plate of a blind-type curtain according to a first exemplary embodiment of the present disclosure, and FIG. 5 is a perspective view of a second clip plate of a blind-type curtain according to a first exemplary embodiment of the present disclosure.

Referring to FIG. 2, the connectors 200 are provided to fasten the curtain blind 100 to the rail, and the connectors 200 are fastened to upper portions of the blackout curtain parts 120 in a clip form. Further, the connectors 200 fastened to the upper portions of the blackout curtain parts 120 in clip form may be engaged with the rail through the connecting rings such that the curtain blind 100 is fastened to the rail via the connectors 200. FIG. 2 shows an example where the connector is coupled by the hook, in which case only one connecting ring is sufficient. FIG. 3 shows an example where the hook is removed and the two connecting rings are connected to the rail ring 212.

Referring to FIGS. 4 and 5, the connector 200 includes a clip plate 211 including a first clip plate contacting one surface of the upper portion of the blackout curtain parts 120, and a second clip plate contacting the other surface of the upper portion of the blackout curtain parts 120, and a connection ring formed on the upper portions of the first and second clip plates. Further, a rail ring 212 coupled to the rail is fastened to the connection ring such that the blackout curtain part 120 is fastened to the rail through the connector 200. In an example, the rail ring 212 and the connecting ring are detachably attached. Further, at least one connector 200 may be fastened to the rail ring 212 through a connection ring. That is, although only one connection ring is illustrated as being connected to the rail ring 212 in the drawing, exemplary embodiments are not limited thereto, and accordingly, two or more connection rings may be connected to the rail ring 212 at a time.

Meanwhile, while FIG. 5 shows only the hooks on the second clip plate for fastening with the first clip plate, the present disclosure is not limited thereto. Accordingly, the opposing surfaces of the first clip plate and the second clip plate may be provided with a plurality of projections such as spikes formed thereon to hold the blackout curtain parts 120 securely.

The first clip plate and the second clip plate respectively include a concave portion, and a convex portion having a diameter at a tip thereof that is greater than the diameter of the concave portion to be force-fit with each other, with the upper portion of the blackout curtain part 120 interposed therebetween. Further, at least one of the first clip plate and the second clip plate may have, on an outer side thereof, a concave portion or a convex portion having a diameter at a tip thereof that is greater than the diameter of the concave portion so as to fasten adjacent connectors 200 with each other. In an example, when the concave portion is formed on the outer side of the first clip plate, it is preferable that the convex portion is formed on the outer side of the second clip plate.

However, the present disclosure is not limited to the example provided above. Accordingly, it is also possible that adjacent connectors 200 are fastened to each other by the slits and the projections, instead of force-fitting by the concave and convex portions.

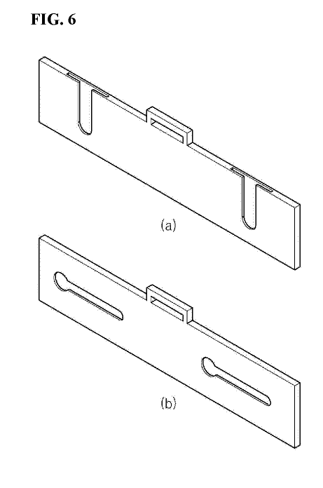

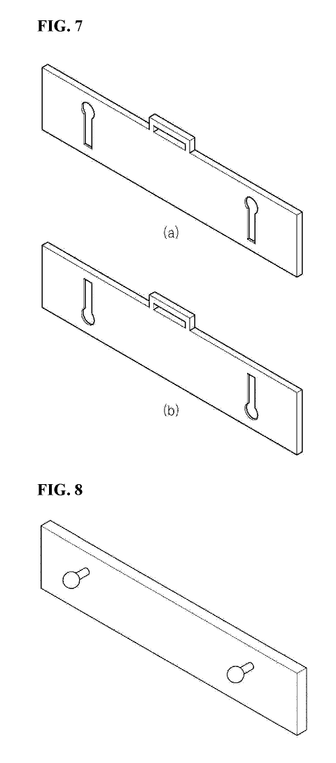

FIGS. 6 and 7 are perspective views showing a first connector for a blind-type curtain according to a modified example of the first embodiment of the present disclosure.

The first connector 210 may be attached to the upper portion of the first blackout curtain part 121, and as shown in FIG. 6A, one side of the slit may be open so that the second connector 220 may be fastened in a direction in which the slit is opened, or as shown in FIG. 6B, the slits may have a different lateral diameter in certain part so that the second connector 220 is inserted into the corresponding slit part. However, the present disclosure is not limited to the example provided above. Accordingly, as shown in FIGS. 7A and 7B, the vertical diameter of a certain part of the slits may be formed differently.

FIG. 8 is a perspective view of a second connector for a blind-type curtain according to a first exemplary embodiment of the present disclosure.

As shown in FIG. 8, the second connector 220 may have a projection having a large diameter at the tip thereof such that the corresponding projection may be fastened to the slit of the first connector 210.

As described above, while it is exemplified herein that the blackout curtain parts 120 are fastened to each other by fastening of the projections and the slits, the present disclosure is not limited thereto. That is, a snap button, a Velcro tape, a magnet, a hook, or the like may be used for fastening of the blackout curtain parts 120. That is, the present disclosure is not limited to any specific fastening structure as long as it can achieve the object of fastening the adjacent blackout curtain parts 120 to each other.

Meanwhile, in an exemplary embodiment, a weight may be additionally provided for promoting the aesthetic appeal of the curtain blind 100.

The weight is provided at the lower end of the curtain blind 100 so that the curtain blind 100 is tightly pulled by the weight of the weight. Further, according to the present disclosure, the possibility that the curtain blind 100 is influenced by the wind can be minimized, and aesthetic appeal can be further increased.

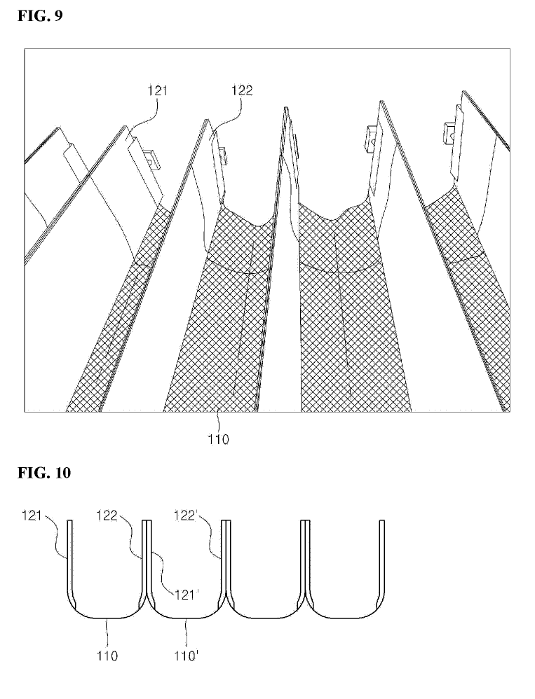

FIG. 9 is a perspective view showing a curtain state of a blind-type curtain according to a first exemplary embodiment of the present disclosure, and FIG. 10 is a top view of FIG. 9.

As shown in FIGS. 9 and 10, in an exemplary embodiment, a blind-type curtain is fabricated, including a plurality of curtain blinds 100 described above. Further, adjacent blackout curtain parts 122, 121′ of the curtain blind 100 are fastened to each other with a connector to thus form a U-shaped blind-type curtain as shown in FIGS. 8 and 9. Accordingly, the present disclosure can increase the aesthetic appeal of the blind-type curtain.

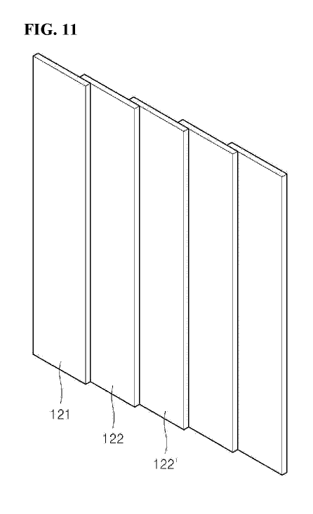

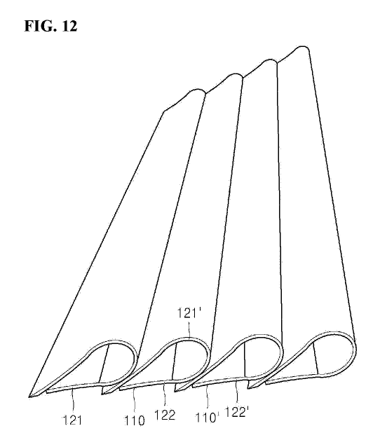

FIG. 11 is a perspective view illustrating a blind-type curtain in a blackout state according to a first exemplary embodiment of the present disclosure, and FIG. 12 is a top view of FIG. 11.

As shown in FIGS. 11 and 12, according to an exemplary embodiment, the rotation of the curtain blind 100 causes the light transmitting curtain part 110 and the second blackout curtain part 122 of the curtain blind 100 to be overlapped with the first blackout curtain part 121′ of another curtain blind 100 adjacent thereto. Accordingly, the blind-type curtain according to the present disclosure is switched to a blackout state.

As described above, in some exemplary embodiments, when in a curtain state, the blind-type curtain may allow external light to be introduced into the room like a general curtain does, and when in a blackout state, the blind-type curtain may provide the same effect as a blackout curtain.

Meanwhile, in some exemplary embodiments, a plurality of curtain blinds described above are provided, and since they are separated from each other, washing and repair due to contamination or damage are easy. That is, what is needed is to separate the connector of the contaminated or damaged curtain blinds and separate only the contaminated or damaged curtain blinds from the rail, and then fasten the separated curtain blinds, which may have been washed or repaired, or newly purchased curtain blinds again with the connectors. Accordingly, it is easy to separate only the contaminated or damaged curtain blinds and wash or replace them.

Further, in some exemplary embodiments, by a structure in which a plurality of separate curtain blinds from each other are fastened to each other at the upper portions by means of connectors, only some curtain blinds are blown in the wind even when the wind blows, and a possibility that the entire curtain type blind is blowing in the wind can be prevented.

Further, the colors of the plurality of curtain blinds may be different from each other, or the patterns may be varied to promote the aesthetic appeal. That is, in some exemplary embodiments, one or more curtain blinds may be selected and applied according to the user's taste.

Next, a curtain blind according to a second exemplary embodiment of the present disclosure having an extension plate formed at a connector will be described with reference to the drawings. The elements or operations of the curtain blind that overlaps those already described above according to the first exemplary embodiment of the present disclosure will be omitted or described as brief as possible for the sake of brevity.

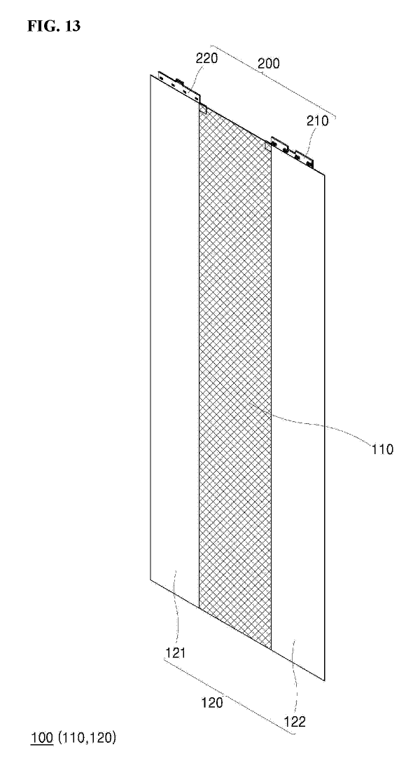

FIG. 13 is a perspective view of a curtain blind according to a second exemplary embodiment of the present disclosure.

As illustrated in FIG. 13, the blind-type curtain according to the second exemplary embodiment of the present disclosure includes a curtain blind 100, and a connector 200 which connects a plurality of separate curtain blinds 100 and which has an extension plate formed thereon to support the light transmitting curtain part 110. The curtain blind 100 will not be redundantly described below, as it is identical to that of the blind-type curtain according to the first embodiment of the present disclosure described above.

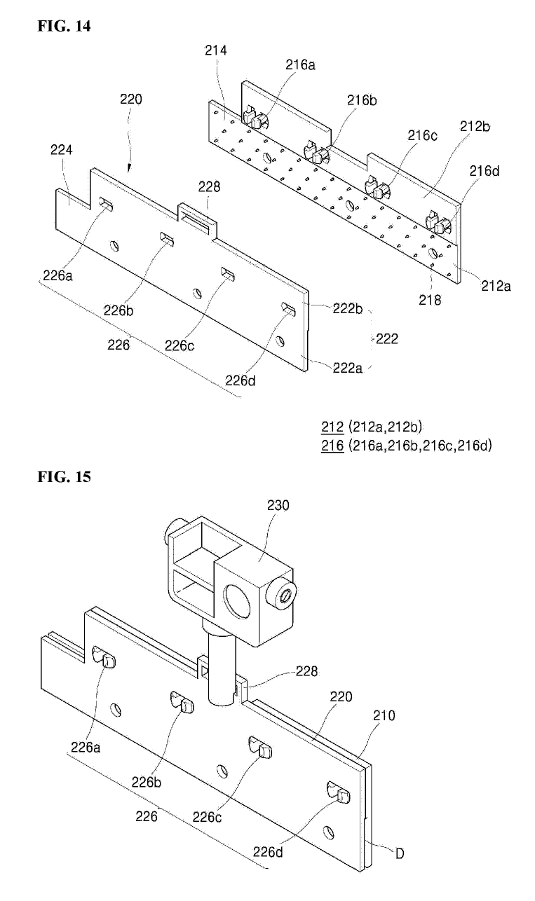

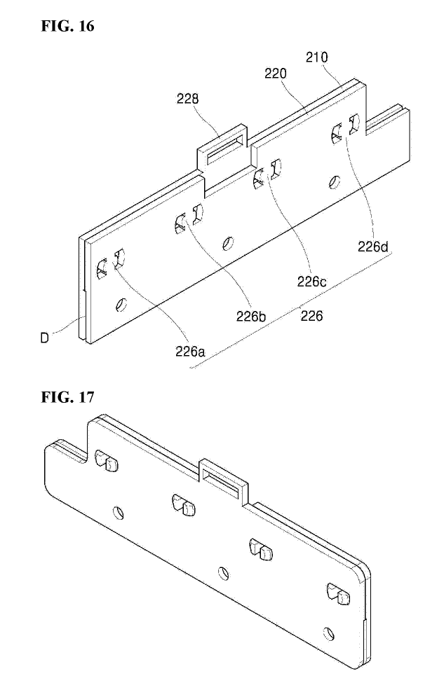

FIG. 14 is a perspective view of a connector for a blind-type curtain according to a second exemplary embodiment of the present disclosure. Further, FIG. 15 is a perspective view showing a connector for a blind-type curtain being connected to a rail ring, according to a second exemplary embodiment of the present disclosure, and FIG. 16 is a perspective view showing a connector for a blind-type curtain coupled according to a second exemplary embodiment of the present disclosure.

Referring to FIGS. 13 and 14, the connector 200 is fastened to the upper portion of the blackout curtain parts 120 in a clip form. Further, the connectors 200 fastened to the upper portions of the blackout curtain parts 120 in clip form may be engaged with the rail through the connecting rings such that the curtain blind 100 is fastened to the rail via the connectors 200.

Referring to FIGS. 14 to 16, the connector 200 includes a first clip plate 210 contacting one surface of the upper portion of the blackout curtain parts 120, and a second clip plate 220 contacting the other surface of the upper portion of the blackout curtain parts 120.

The first clip plate 210 includes a first base plate 212 having a rectangular shape, a first extension plate 214 extending from one edge of the first base plate 212, a hook protruding from one region of one surface of the first base plate 212, and a spike 218 protruding from the other region of one surface of the first base plate 212.

The first base plate 212 has a rectangular shape as described above, and is divided into a first base plate upper portion 212b as an upper region where the hook 216 is formed, and a first base plate lower portion 212a as a lower region where the spike 218 is formed. The first extension plate 214 is formed at one edge of the first base plate lower portion 212a.

The first extension plate 214 extends from the first base plate 212 and supports the blackout curtain part 120 on the side surface of the first base plate 212. According to some exemplary embodiments, the light transmitting curtain part 110 is curved by the fastening of the connector 200 so that the curtain blind 100 is formed into a U-shape, but when there is no first extension plate 214 at the connector 200, the U-shape will not be formed properly. Accordingly, according to the present disclosure, an extension plate is formed on the base plate, and the first base plate lower portion 212a and the second base plate lower portion 222a are overlapped each other to support the blackout curtain parts 120, and the first extension plate 214 and the second extension plate 224 support the light transmitting curtain part 110 so that the curtain blind 100 can easily be formed into a U-shape.

Meanwhile, although it is exemplified herein that the first extension plate 214 and the second extension plate 224 are extended on the first base plate 212 and the second base plate 222, respectively, exemplary embodiments are not limited thereto. That is, an elastic member serving as an extension plate may be provided between the first base plate 212 and the second base plate 222 such that the light transmitting curtain part 110 may be more easily formed into a U-shape by the elastic bending. In an example, the elastic member has a shape in which the first base plate lower portion 212a and the first extension plate 214 are connected. Of course, only the first extension plate 214 extending from the first base plate lower portion 212a may be formed of an elastic member, or both the first extension plate 214 and the second extension plate 224 may be formed of an elastic member.

Further, in some exemplary embodiments, the lower edges of the first base plate 212 and the first extension plate 214, and the second base plate 222 and the second extension plate 224 may be formed in a wavy shape, that is, in a continuous pattern of half circles such that wrinkling of the blackout curtain parts 120 at the boundary between the first clip plate 210 and the second clip plate 220 is prevented.

Meanwhile, in some exemplary embodiments, the first clip plate 210 and the second clip plate 220 may have the fastening structure as shown in FIGS. 6 to 8.

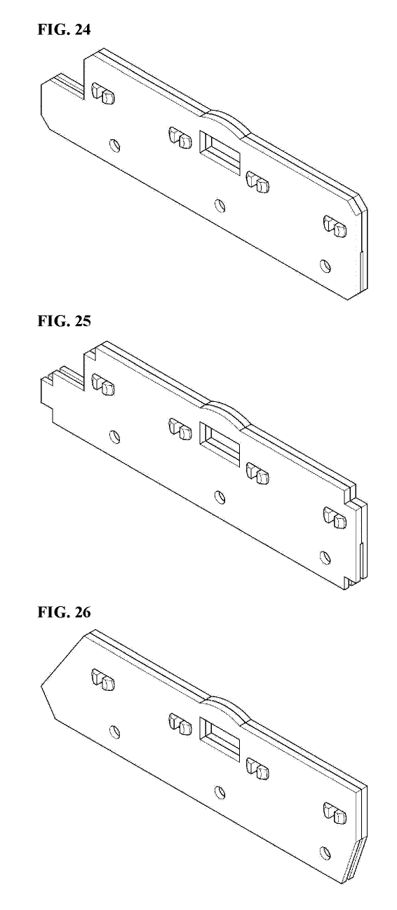

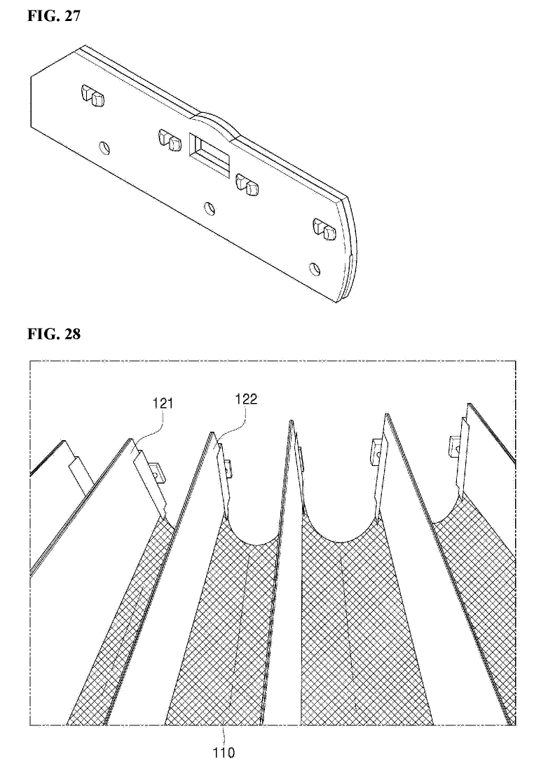

FIGS. 17 to 27 are perspective views showing a connector for a blind-type curtain coupled according to a modified example of the second exemplary embodiment of the present disclosure.

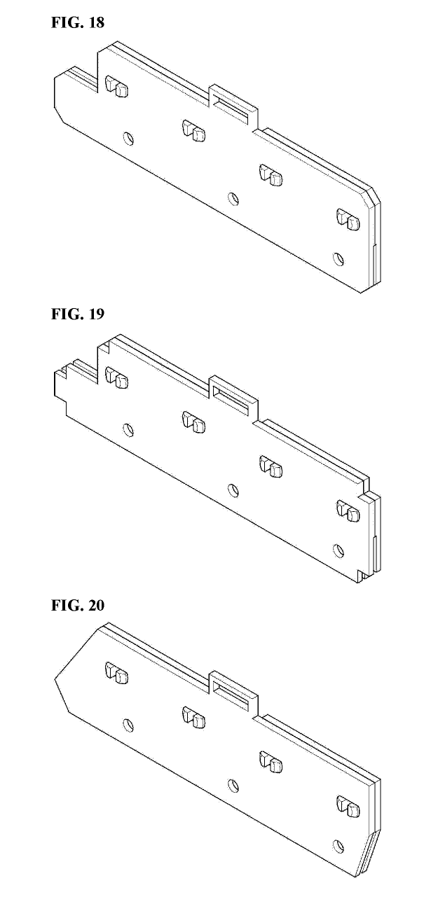

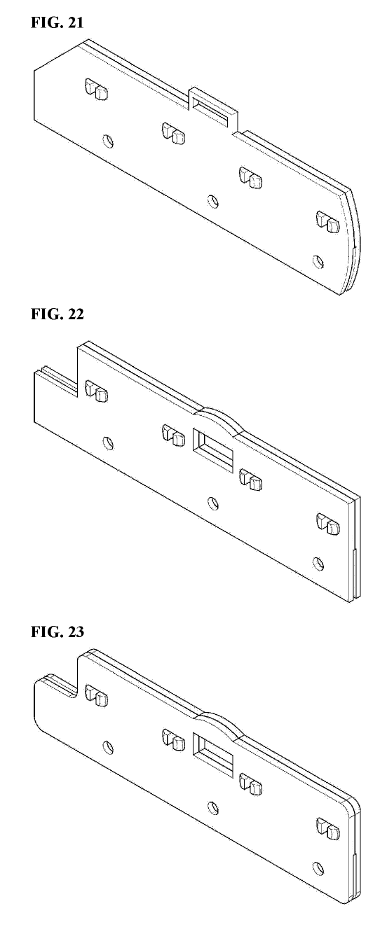

Meanwhile, in some exemplary embodiments, a modified form of a connector for a blind-type curtain may be provided, as shown in FIGS. 17 to 27. This may include the edge of the connector 200 rounded as shown in FIG. 17, or the edge of the connector 200 chamfered as shown in FIG. 18. Further, the modified form may include the edge of the connector 200 formed into a stepped shape as shown in FIG. 19, or both edges of the connector 200 angled as shown in FIG. 20. Further, the modified form may include rounded one edge of the connector 200 and angled other edge of the connector 200, as shown in FIG. 21. Of course, as shown in FIGS. 22 to 27, in the above-described modified examples, the connection ring may be formed on the second base plate upper portion 222b without protruding upward.

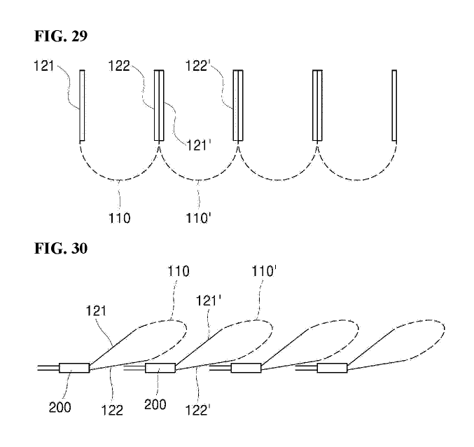

FIG. 28 is a perspective view illustrating a curtain state of a blind-type curtain according to a second exemplary embodiment of the present disclosure, and FIG. 29 is a top view of FIG. 28.

As shown in FIG. 9, the related blind-type curtain does not properly maintain the U-shape, whereas in the exemplary embodiment of the present disclosure as shown in FIGS. 28 and 29, a perfect U-shaped blind-type curtain is formed in which the adjacent blackout curtain parts 122, 121′ of the curtain blind 100 are fastened to each other with the connector. Accordingly, in some exemplary embodiments, the aesthetic appeal of the blind-type curtain can be further increased.

FIG. 30 is a top view illustrating a blind-type curtain in a blackout state according to a second exemplary embodiment of the present disclosure.

As shown in FIG. 30, in some exemplary embodiments, by the rotation of the curtain blind 100, the light transmitting curtain part 110 of one curtain blind 100, the second blackout curtain part 122, and the first blackout curtain part 121′ of another curtain blind adjacent thereto are overlapped with each other. Accordingly, the blind-type curtain according to the present disclosure is switched to a blackout state.

As described above, exemplary embodiments of the present disclosure can provide a perfect U-shaped blind-type curtain by forming, on the connector, an extension plate for supporting the light transmitting curtain part.

The present disclosure has been described in detail. However, it should be understood that the detailed description and specific examples, while indicating preferred embodiments of the disclosure, are given by way of illustration only, since various changes and modifications within the scope of the disclosure will become apparent to those skilled in the art from this detailed description.

What is claimed is:

1. A connector for a blind-type curtain, provided for a plurality of curtain blinds comprising a light transmitting curtain part and blackout curtain parts provided on both sides of the light transmitting curtain part, wherein the connector is provided on the blackout curtain parts to fasten adjacent blackout curtains parts to each other and comprises:
a first clip plate having a first base plate, and a first fastening member protruding from one region of one surface of the first base plate; and
a second clip plate having a second base plate having a corresponding shape to the first base plate, a second fastening member formed on one region of one surface of the second base plate to be coupled with the first fastening member, and a connection ring extending upwardly from a center of an edge of the second base plate.

2. The connector of claim 1, further comprising:
the first clip plate having a spike protruding from other region of one surface of the first base plate; and
a spike coupling hole formed in other region of one surface of the second base plate to be coupled with the spike.

3. The connector of claim 2, comprising:
a first extension plate extending from one edge of the first base plate; and
a second extension plate extending from one edge of the second base plate and having a corresponding shape to the first extension plate,
wherein, when the curtain blinds are in a curtain state by the first extension plate and the second extension plate, the light transmitting curtain part is kept in a U-shape.

4. The connector of claim 3, wherein the first extension plate and the second extension plate are elastic members.

5. A blind-type curtain comprising a plurality of curtain blinds, wherein the curtain blinds comprise a light transmitting curtain part and blackout curtain parts, wherein the blackout curtain parts are provided on both sides of the light transmitting curtain part and fastened with the blackout curtain parts adjacent thereto by a connector, wherein
the connector comprises:
a first clip plate having a first base plate, and a first fastening member protruding from one region of one surface of the first base plate; and
a second clip plate having a second base plate having a corresponding shape to the first base plate, a second fastening member formed on one region of one surface of the second base plate to be coupled with the first fastening member, and a connection ring extending upwardly from a center of an edge of the second base plate.

6. The connector of claim 5, further comprising:
the first clip plate having a spike protruding from other region of one surface of the first base plate; and
a spike coupling hole formed in other region of one surface of the second base plate to be coupled with the spike.

7. The connector of claim 6, comprising:
a first extension plate extending from one edge of the first base plate; and
a second extension plate extending from one edge of the second base plate and having a corresponding shape to the first extension plate,
wherein, when the curtain blinds are in a curtain state by the first extension plate and the second extension plate, the light transmitting curtain part is kept in a U-shape.

8. The connector of claim 7, wherein the first extension plate and the second extension plate are elastic members.

9. The connector of claim 8, wherein the curtain blinds are woven.

10. The connector of claim 9, wherein the light transmitting curtain part has a less thickness than the blackout curtain parts.

11. The connector of claim 10, wherein the connector is provided on an upper portion of the blackout curtain parts, and
a connection ring is formed on an upper portion of the connector to be connected with a curtain rail.

12. The connector of claim 11, wherein the connector comprises:
a first connector having a slit formed therein; and
a second connector having a projection to be fastened with the slit.

13. The connector of claim 12, wherein an angle of rotation of the curtain blinds is controlled with the connector.

14. The connector of claim 13, wherein the plurality of curtain blinds have different colors and patterns.

15. The connector of claim 14, further comprising a weight detachably attached to a lower end of the curtain blinds.
